(19) United States
(12) Patent Application Publication
(10) Pub. No.: US 2017/0311424 A1
(43) Pub. Date: Oct. 26, 2017

(54) LUMINAIRE DIMMING MODULE USES 3 CONTACT NEMA PHOTOCONTROL SOCKET

(71) Applicant: Express Imaging Systems, LLC, Renton, WA (US)

(72) Inventors: Don Arthur Vendetti, Seattle, WA (US); William G. Reed, Seattle, WA (US)

(21) Appl. No.: 15/496,985

(22) Filed: Apr. 25, 2017

Related U.S. Application Data
(60) Provisional application No. 62/327,939, filed on Apr. 26, 2016.

(51) Int. Cl. H05B 37/02; H05B 39/09; H05B 33/08; H05B 39/04

(52) U.S. Cl. CPC H05B 37/0272; H05B 39/041; H05B 39/09; H05B 33/0803; H05B 33/0845

(57) ABSTRACT

An article and circuit that controllably dims a luminaire, for example without controlling a line power of the luminaire. The luminaire includes a traditional three-contact socket to receive a photocontroller, such as that used for street lights. The article uses a desired dimming control signal to provide an output control signal that controls whether the light source in the luminaire is turned ON or turned OFF to thereby effect the desired amount of dimming. The output control signal may be a pulse width modulated (PWM) signal with a duty cycle that is related to the desired level of illumination or dimming. The system may use a dimming signal from a five or seven contact dimming photocontroller to provide such an output control signal to control the light-level for the luminaire.

### BACKGROUND

### Technical Field

The present disclosure is related to lighting, and in particular to retrofits for legacy outdoor lights or luminaires, for instance street lights, lights in parking lots and other area lighting or luminaries.

### Description of the Related Art

It is desirable to be able to dim the intensity of solid state luminaires, for example street and area lights, using wireless or Power Line Carrier control systems. A NEMA standard socket with 5 or 7 contacts is often used for this purpose. Traditional 3 contact NEMA sockets have been used with “Dusk to Dawn” photocontrols which are only able to turn the luminaire ON or OFF.

### BRIEF SUMMARY

A dimmer plug that is coupleable to a three contact socket of a luminaire, the three contact socket having three female receptacles, may be summarized as including a housing having a first face; only three male electrical contacts, the three male electrical contacts which extend from the first face of the housing, and arranged with respect to one another in a first arrangement; a receiver housed by the housing and operable to receive input signals; and circuitry housed by the housing and communicatively coupled to the receiver, the circuitry operable to provide an output signal via one of the three male electrical contacts based on the input signals received by the receiver. Circuitry may control dimming of the luminaire without controlling a line power of the luminaire. Circuitry may produce the output signal as a pulse-width modulated signal. Circuitry may adjust a duty cycle of the pulse-width modulated signal to adjust a level of illumination produced by the luminaire. Circuitry may produce the output signal as a frequency modulated signal. Circuitry may produce the output signal as a digitally coded signal. Circuitry may produce the output signal as an analog signal with a range of 0 volts to 100 volts.

The receiver may be a radio receiver and may further include an antenna communicatively coupled to the radio receiver to wirelessly receive the input signals. The receiver may be a wire-line receiver electrically coupled to receive the input signals via an electrical power line coupled to the luminaire. The three male electrical contacts may include an AC line contact, an AC neutral contact, and a control signal contact. The only three male electrical contacts may be sized, dimensioned, shaped, and may be arranged with respect to one another according to fit a socket that complies with a National Electrical Manufacturer Association (NEMA) C136 specification, such as the NEMA C136.10 specification, in existence as of Jan. 1, 2016. The dimmer plug may be a twist lock plug. The housing may have a thickness and a second face, the second face opposed across the thickness of the housing from the first face, and the housing may include a plurality of female electrical contacts accessible from the second face, the female electrical contacts electrically coupled to the circuitry. The housing may include either five or seven electrical contacts accessible from the second face. The five or seven electrical contacts may be sized, dimensioned, shaped and arranged to receive at least one of a five position dimming controller and a seven position dimming controller. The housing may include a plurality of pad electrical contacts accessible from the second face. The circuitry may receive the input signals from the dimming controller.

The dimmer plug may further include a light sensor communicatively coupled to the circuitry to provide the circuitry with an electrical signal representative of light sensed by the light sensor. The light sensor may include at least one of either a photo-sensor, a photodetector, and a photo-diode.

A dimmer plug that is coupleable to a three contact socket of a luminaire, the three contact socket having three female receptacles may be summarized as including: a housing having a first face; only three male electrical contacts, the three male electrical contacts which extend from the first face of the housing, and arranged with respect to one another in a first arrangement; a receiver housed by the housing and operable to receive an input signal that is not obtained from a light sensor; and circuitry housed by the housing and communicatively coupled to the receiver, the circuitry operable to provide an output signal via one of the three male electrical contacts based on the input signals received by the receiver.

The circuitry may be operable to control dimming of the luminaire without controlling a line power of the luminaire. The input signal received by the receiver may be not representative of a level of light in an external environment, and the circuitry may be operable to control dimming of the luminaire based at least in part on the input signal that is not representative of a level of light in the external environment.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1 is an isometric view of a dimmer plug which houses a receiver, and which has three contacts, according to at least one illustrated implementation.

FIG. 2 is a circuit schematic illustrating the dimmer plug in a circuit with an AC power source, according to at least one illustrated implementation.

FIG. 3 is a timing diagram showing a representative pulse width modulated signal produced by the dimmer plug, according to at least one illustrated implementation.

FIG. 4 is a schematic diagram showing the dimmer plug coupled to a luminaire, according to at least one illustrated implementation.

FIG. 5 is a side elevational view of a dimmer plug with at least some of the interior components illustrated in broken line, according to at least one illustrated implementation.

FIG. 6 is an isometric view of a luminaire that includes a covered light source and a three-prong socket, along with a corresponding dimmer plug and five-contact and/or seven-contact dimmer controller, according to at least one illustrated implementation.

### DETAILED DESCRIPTION

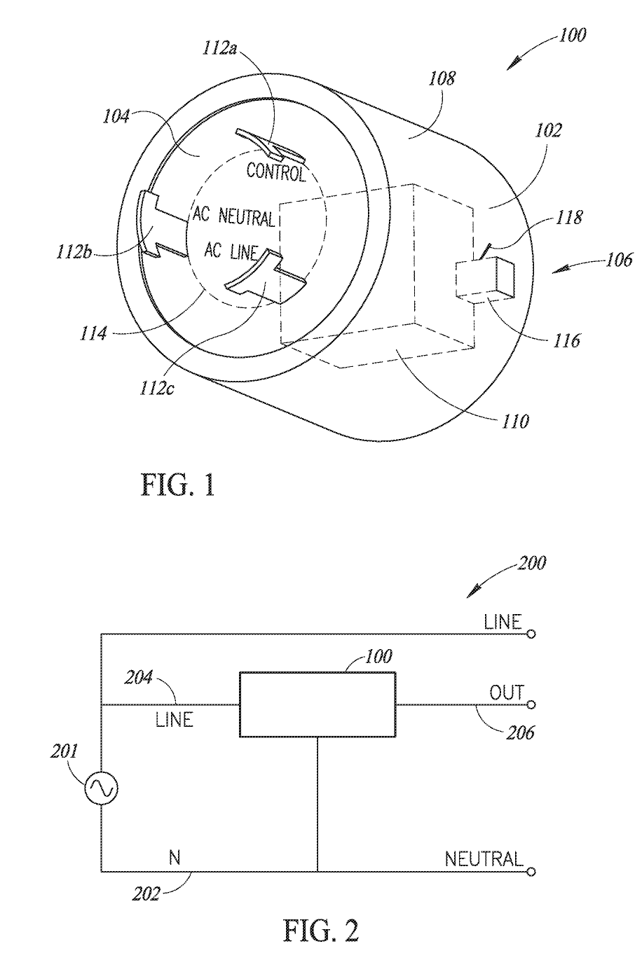

FIG. 1 shows a dimmer plug 100 that removably plugs into a 3 contact socket, according to at least one illustrated implementation.

The dimmer plug 100 may comprise a 3 contact socket that complies with a specific standard or specification. For example, the dimmer plug 100 may comprise a 3 contact socket that complies with a National Electrical Manufacturer

Association (NEMA) standard or specification or an American National Standards Institute (ANSI) standard or specification, for instance the ANSI C136.10 standard or specification, in existence as of Jan. 1, 2016. The dimmer plug 100 includes a body or housing 102 that houses a dimming circuit 110 and a receiver 116, the receiver communicatively coupled to the dimming circuit 110. The dimming circuit 110 provides dimming of a luminaire to which the dimmer plug 100 is attached, without controlling the line power to the luminaire.

The dimmer plug body or housing 102 has a first face 104 and a second face 106 opposed across a thickness of the body or housing 102 from the first face 104. The body or housing 102 may include one or more side walls 108 that extend between the first and the second faces 104, 106, respectively. In some implementations, the side wall 108 may have an annular cross-section, the housing 108 being cylindrical with the first face 104 at one end of the cylinder and the second face 106 at a second end of the cylinder. The body or housing 102 is not limited to circular profiles, and may have an oval, rectangular, hexagonal or even a free-form profile.

Three male electrical contacts 112a, 112b, 112c (collectively, male electrical contacts 112) may extend perpendicularly from the first face 104. A first one of the male electrical contacts 112a, denominated as control signal contact 112a, may be used to provide an output control signal that controls whether the lighting element in the luminaire is turned ON or turned OFF. In a conventional three-prong photocontroller plug, the control signal contact may provide an AC switch line signal that turns the light source in the luminaire ON at dusk and OFF at dawn, in response to ambient light sensed by a light sensor. As used in the dimmer plug 100, the control signal contact 112a may be used to provide a control signal that selectively cycles the light source in the luminaire ON and OFF to effectively dim the light output of the light source by a selected amount. The second male electrical contact, denominated as AC neutral contact 112b, may provide a connection to the AC neutral line. The third male electrical contact, denominated as AC line contact 112c, may provide a connection to the AC line. The AC neutral contact 112b and the AC line contact 112c may be electrically coupled to a power line and provide electrical power to the luminaire and/or to the dimmer plug 100.

The male electrical contacts 112 may be arranged with respect to each other in a first arrangement. For example, in some implementations, the male electrical contacts 112 may be spaced at equal distances around a circular region 114 included within the first face 104. In some implementations, the male electrical contacts 112 may be sized, dimensioned, shaped, and arranged with respect to each other in order to fit into a socket that complies with a NEMA or ANSI specification or standard, such as the ANSI C136.10 specification or standard in existence on Jan. 1, 2016. In such an implementation, the dimmer plug 100 may fit into a luminaire socket having three complementary female receptacles that correspond to the three male electrical contacts 112. In some implementations, the dimmer plug 100 may comprise a twist-lock plug in which the male electrical contacts 112 may be inserted into and twisted with respect to the corresponding female receptacles to thereby physically securely lock the dimmer plug 100 with the luminaire socket. The twist-lock dimmer plug 100 may be selectively releasable from the luminaire socket, for example by twisting in an opposite direction from the direction used to secure the twist-lock dimmer plug 100 to the luminaire socket.

The dimming circuit 110 may be housed by the body or housing 102, for example enclosed therein. The body or housing 102 may be electrically insulative and may provide environmental protection to the dimming circuit 110. The dimming circuit 110 may include a processor and/or micro-processor and/or micro-controller that execute machine-executable instructions. The dimming circuit 110 may also include one or more non-transitory memories that may store one or more lighting and/or dimming programs operable, when executed by the processor within the dimming circuit 110, to dim the luminaire without controlling the line power provided to the luminaire by, e.g., the AC line signal and AC neutral signal provided from the power line. For example, in some implementations, the dimming circuit 110 may be operable to provide a dimming level signal via the control signal contact 112a. Such a dimming level signal may, for example, be in the form of a pulse width modulated signal, an analog signal, a frequency modulated signal or a digitally coded signal such as ANSCI serial protocol compliant signal, that selectively turns the light source in the luminaire on and off, as discussed below.

The dimming circuit 110 may be electrically and communicatively coupled to a receiver 116 that may be operable to receive input signals that are associated with and indicate specific output signals for effectively dimming the light source of a luminaire. For example, in one embodiment, a Power Line Carrier receiver is coupled to the input power lines and receives the input signals from a remote source, for example from a central network controller. The Power Line Carrier receiver may provide the input signals to the dimming circuit 110 to provide the appropriate output control signals. In some implementations, the input signals may be received by a radio wireless receiver 116 such as a WiFi or Bluetooth radio transceiver that includes an antenna 118. The radio wireless receiver may provide the input signals to the dimming circuit 110 to provide the appropriate output control signals.

In any implementation, the receiver 116 of the dimmer plug 100 receives the transmitted input signal, and the circuitry of the dimming circuit 110 (e.g., analog logic circuitry, digital microcontroller or microprocessor) and/or the instructions executed by the dimming circuit 110 provide an output signal based on the received input signal. For example, in at least some implementations, the input signal received by the receiver 116 is provided to a high voltage solid state switch (e.g., MOSFET, IGBT). The high voltage solid state switch may use analog logic circuitry or digital logic (e.g., a microcontroller) to provide a pulse width modulated signal with a defined period (e.g., 4 seconds) and a voltage level equal to the line voltage based on a dimming level command included within the received input signal.

FIG. 2 shows a circuit 200 which includes a dimmer plug 100 electrically coupled to an AC power source 201. The dimmer plug 100 receives the AC neutral input from AC neutral input line 202 and the AC line signal from the AC line 204 as inputs. The dimming circuit 110 (FIG. 1) may produce an output signal to be provided via an output line 206 to the control signal contact 112a based at least in part on a dimming level command received in a control signal, as discussed above.

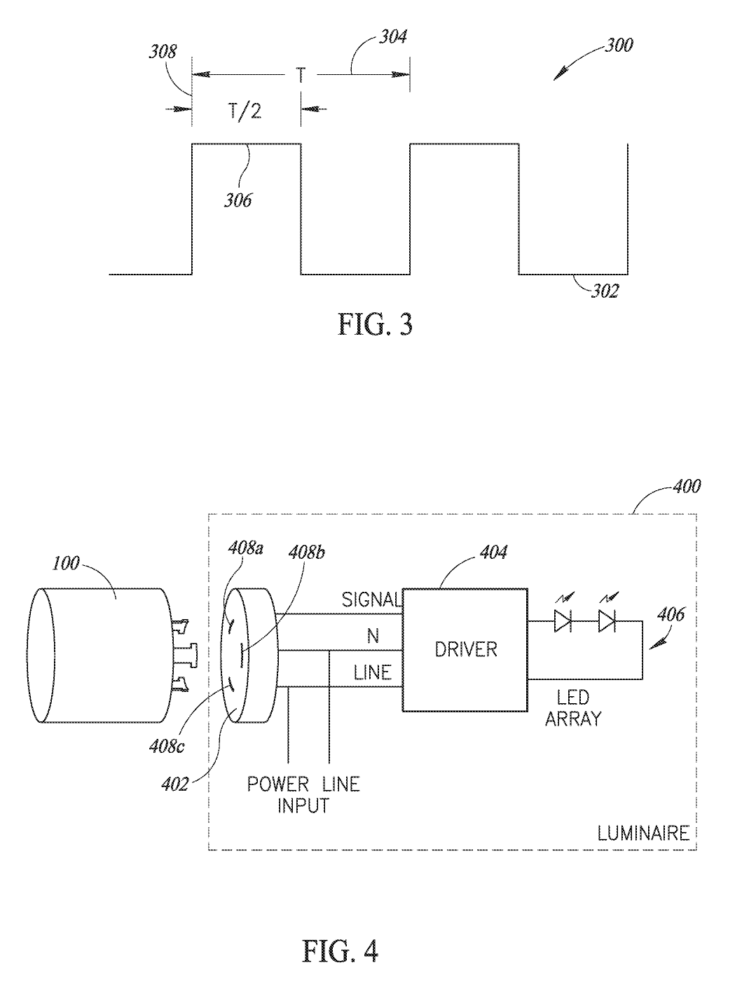

FIG. 3 shows a timing diagram 300 for an output signal 302 in the form of a pulse width modulated signal. In such an implementation, the dimmer plug 100 and dimming circuit 110 outputs, for example, a pulse width modulated signal as an output signal 302 wherein the dimming level is proportional to the pulse width of a constant period 304, for example a period of 4 seconds. In this example, a high pulse 306 that lasts for a duty cycle 308 of two (2) seconds represents approximately a dimming level of 50% of full brightness. In this example, a constant high signal causes the luminaire to operate at full brightness, and a constant low signal causes the luminaire to operate at 0 brightness (full OFF). In such an implementation, the amount of dimming for the luminaire may be adjusted by adjusting the duration of the duty cycle 308 in proportion to the duration of the pulse width 304.

In one implementation, the output signal provided via the control signal contact 112a is an analog signal with a range of 0 volts to 10 volts. In another implementation, the output signal provided via the control signal contact 112a is an analog signal with a range of 0 volts to 100 volts.

FIG. 4 shows a dimmer plug 100 and a luminaire 400, the luminaire having an LED driver 404, a light source 406, and a standard socket 402 to which the dimmer plug 100 mechanically and electrically mates or interfaces. The socket 402 may include three female receptacles (collectively, female receptacles 408) that are sized, spaced, dimensioned and arranged to securely, electrically couple with a dimmer plug 100 that has three complementary male contacts 112. The first female receptacle may correspond to a power source input receptacle 408a for a standard three-prong photocontrol unit. The power source input receptacle 408a may be electrically coupled to a control input on the driver 404, wherein the driver 404 includes circuitry that may be operable to selectively turn the light source 406 ON and OFF in response to the signal received via the power source input receptacle 408a. The luminaire 400 may have a high impedance input, for example 1 meg ohms, which couples the output signal received via the power source input receptacle 408a to the power converter part of the luminaire, for example, the LED driver 404.

The second female receptacle may correspond to the AC neutral line receptacle 408b that may be used to supply the signal from the AC neutral line to the dimmer plug 100. The third female receptacle may correspond to the AC line receptacle 408c that may be used to supply the AC line signal to the dimmer plug 100. As noted previously, the signal received via the power source input receptacle 408a may be used to control a dimming level for the light source 406 without controlling the line power input to the luminaire 400 via the AC neutral line receptacle 408b and the AC line receptacle 408c.

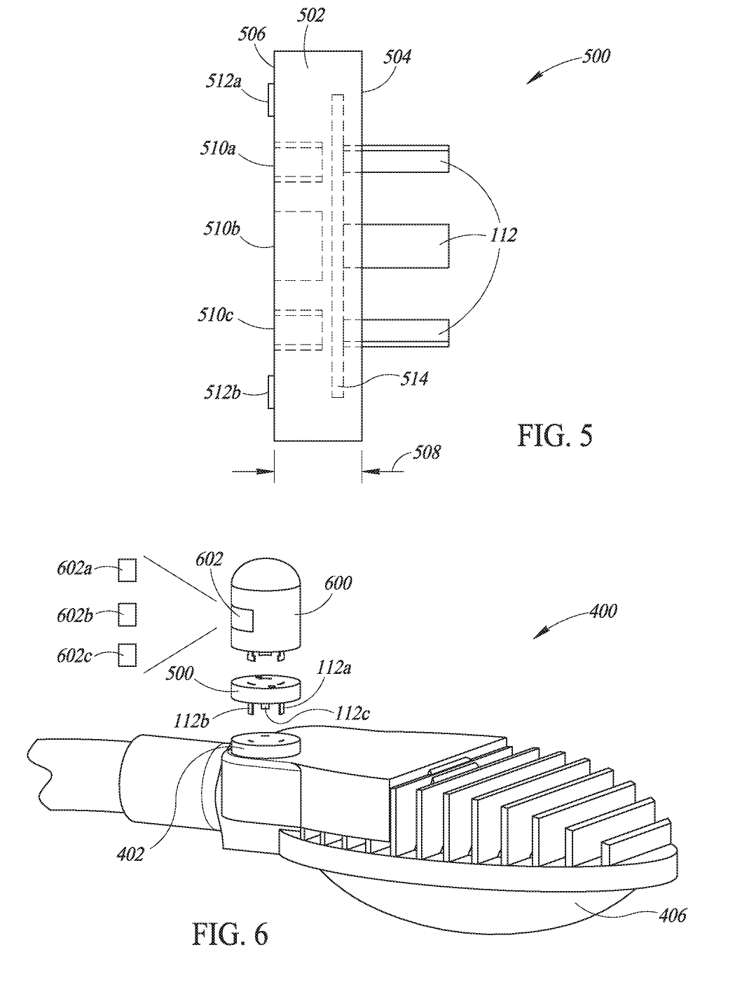

FIG. 5 shows a dimmer plug 500 with broken lines to denote internal components. The dimmer plug 500 may be placed between a five-contact photocontrol unit, a seven-contact photocontrol unit, or similar a photocontrol unit with more than three contacts, and a luminaire 400 that has a standard three-contact socket 402. The dimmer plug 500 includes a housing 502 that has a first face 504 and an opposing second face 506 that are separated by a thickness 508. One or more side walls 510 expand across the thickness 508 to connect the first face 504 and the second face 506. The first face 504 includes the three male electrical contacts 112 as discussed above. The second face 506 includes a plurality of electrical contacts that are sized, shaped, and dimensioned to electrically couple with other configurations of photocontrol units that may have more than three contacts. In some implementations, as least some of the electrical contacts on the second face 506 may include one or more female contacts, such as female contacts 510a, 510b, and 510c (collectively, female receptacles 510). In some implementations, at least some of the electrical contacts on the second face 506 may be pad contacts, such as pad contacts 512a and 512b (collectively, pad contacts 512). Such pad contacts 512 may be included on or proximate the surface of the second face 506 and make electrical contact with corresponding, complementary pad contacts included, for example, on the corresponding surface of a photocontrol unit.

The second face 506 may have any combination of female receptacles 510 and pad contacts 512. In some implementations, for example, all of the electrical contacts on the second face may be female contacts 510. In other implementations, all of the contacts on the second face may be pad contacts 512. In yet other implementations, the contacts may be a combination of female contacts 510 and pad contacts 512. In some implementations, for example, the second face 506 of the dimmer plug 500 may include three female contacts 510 that may be used to connect to male contacts of older, legacy photocontrol units. Such a second face 506 may include additional pad contacts 512 that may be used for additional functionality provided by relatively newer photocontrol units. For example, in some implementations, the female receptacles 510 and/or pad contacts 512 may be sized, spaced, and dimensioned on the second face 506 to electrically and communicatively couple to corresponding electrical contacts (e.g., male connectors and pad contacts) on a five-position and/or a seven-position dimming controller.

The housing 502 may enclose or house a dimming control circuit 514. In some implementations, the dimming control circuit 514 may be operable to receive dimming control signals input by a photocontrol unit electrically and communicatively coupled to the female contacts 510 and/or pad contacts 512 on the second face 506 of the dimmer plug 500. The dimming control circuit 514 may produce an output signal that can be provided via the control signal contact 112a to selectively dim the light output of the luminaire 400 with a three-receptacle socket 402 based at least in part on the dimming control signals received from the five-contact or the seven-contact dimming controller. The light output of the light source 406 on such a luminaire 400 may be controllably, selectively dimmed according to the control signal received via the control signal contact 112a using the techniques described above.

FIG. 6 shows the luminaire 400 that includes a covered light source 406 and a three-prong socket 402, along with a corresponding dimmer plug 500 and five-contact and/or seven-contact dimmer photocontrol unit 600. The dimmer photocontrol unit 600 may include a light sensor 602 that includes one or more of a photo-sensor 602a, a photodetector 602b, and/or a photo-diode 602c. The light sensor 602 may produce an electrical signal representative of the amount of light sensed or detected by the light sensor 602. In such an implementation, the voltage level of the electrical signal may be used to indicate a desired dimming level of the covered light source 406.

The dimmer plug 500 may produce a dimming control signal based on the dimming signals received from the five-contact and/or seven-contact dimmer photocontrol unit 600. The dimming control signal may be input via the control signal contact 112a to controllably dim the light source 406 in the luminaire 400 that has a socket 402 configured to receive a three-pin dimmer plug. As such, the light output of the covered light source 406 may be dimmed without controlling the line power for the luminaire 400. In some implementations, for example, the five-contact and/or seven-contact dimmer photocontrol unit 600 may transmit a dimming level control signal that is between zero volts and ten volts. The voltage level of the dimming level control signal may indicate the desired dimming level and/or light intensity (e.g., a voltage level of 7 volts out of 10 volts may indicate 70% light intensity and 30% dimming). In such an implementation, the dimming control circuit 514 (FIG. 5) may be operable produce a pulse-width modulated signal that is input to the control signal contact on the three-prong socket 402 to cause the desired level of dimming on the luminaire 400 based at least in part on the dimming level control signal received from the five-contact and/or seven-contact dimmer photocontrol unit 600, as discussed above.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/052,924, filed May 13, 2008; U.S. Pat. No. 8,926,138, issued Jan. 6, 2015; PCT Publication No. WO2009/140141, published Nov. 19, 2009; U.S. Provisional Patent Application No. 61/051,619, filed May 8, 2008; U.S. Pat. No. 8,118,456, issued Feb. 21, 2012; PCT Publication No. WO2009/137696, published Nov. 12, 2009; U.S. Provisional Patent Application No. 61/088,651, filed Aug. 13, 2008; U.S. Pat. No. 8,334,640, issued Dec. 18, 2012; U.S. Provisional Patent Application No. 61/115,438, filed Nov. 17, 2008; U.S. Provisional Patent Application No. 61/154,619, filed Feb. 23, 2009; U.S. Patent Publication No. 2010/0123403, published May 20, 2010; U.S. Non-provisional Patent Application No. 14/806,500, filed Jul. 22, 2015; PCT Publication No. WO2010/057115, published May 20, 2010; U.S. Provisional Patent Application No. 61/174,913, filed May 1, 2009; U.S. Pat. No. 8,926,139, issued Jan. 6, 2015; PCT Publication No. WO2010/127138, published November 4, 2010; U.S. Provisional Patent Application No. 61/180,017, filed May 20, 2009; U.S. Pat. No. 8,872,964, issued Oct. 28, 2014; U.S. Patent Publication No. 2015/0015716, published Jan. 15, 2015; PCT Publication No. WO2010/135575, published Nov. 25, 2010; U.S. Provisional Patent Application No. 61/229,435, filed Jul. 29, 2009; U.S. Patent Publication No. 2011/0026264, published Feb. 3, 2011; U.S. Provisional Patent Application No. 61/295,519, filed Jan. 15, 2010; U.S. Provisional Patent Application No. 61/406,490, filed Oct. 25, 2010; U.S. Pat. No. 8,378,563, issued Feb. 19, 2013; PCT Publication No. WO2011/088363, published Jul. 21, 2011; U.S. Provisional Patent Application No. 61/333,983, filed May 12, 2010; U.S. Pat. No. 8,541,950, issued Sep. 24, 2013; PCT Publication No. WO2010/135577, published Nov. 25, 2010; U.S. Provisional Patent Application No. 61/346,263, filed May 19, 2010; U.S. Pat. No. 8,508,137, issued Aug. 13, 2013; U.S. Pat. No. 8,810,138, issued Aug. 19, 2014; U.S. Pat. No. 8,987,992, issued Mar. 24, 2015; PCT Publication No. WO2010/135582, published Nov. 25, 2010; U.S. Provisional Patent Application No. 61/357,421, filed Jun. 22, 2010; U.S. Patent Publication No. 2011/0310605, published Dec. 22, 2011; PCT Publication No. WO2011/163334, published Dec. 29, 2011; U.S. Pat. No. 8,901,825, issued Dec. 2, 2014; U.S. Patent Publication No. 2015/0084520, published Mar. 26, 2015; PCT Publication No. WO2012/142115, published Oct. 18, 2012; U.S. Pat. No. 8,610,358, issued Dec. 17, 2013; U.S. Provisional Patent Application No. 61/527,029, filed Aug. 24, 2011; U.S. Pat. No. 8,629,621, issued Jan. 14, 2014; PCT Publication No. WO2013/028834, published Feb. 28, 2013; U.S. Provisional Patent Application No. 61/534,722, filed Sep. 14, 2011; U.S. Patent Publication No. 2013/0062637, published Mar. 14, 2013; PCT Publication No. WO2013/040333, published Mar. 21, 2013; U.S. Provisional Patent Application No. 61/567,308, filed Dec. 6, 2011; U.S. Patent Publication No. 2013/0163243, published Jun. 27, 2013; U.S. Provisional Patent Application No. 61/561,616, filed Nov. 18, 2011; U.S. Patent Publication No. 2013/0141010, published Jun. 6, 2013; PCT Publication No. WO2013/074900, published May 23, 2013; U.S. Provisional Patent Application No. 61/641,781, filed May 2, 2012; U.S. Patent Publication No. 2013/0293112, published Nov. 7, 2013; U.S. Patent Publication No. 2013/0229518, published Sep. 5, 2013; U.S. Provisional Patent Application No. 61/640,963, filed May 1, 2012; U.S. Patent Publication No. 2013/0313982, published Nov. 28, 2013; U.S. Patent Publication No. 2014/0028198, published Jan. 30, 2014; U.S. Non-provisional patent application Ser. No. 14/816,754, filed Aug. 3, 2015; PCT Publication No. WO2014/018773, published Jan. 30, 2014; U.S. Provisional Patent Application No. 61/723,675, filed Nov. 7, 2012; U.S. Patent Publication No. 2014/0159585, published Jun. 12, 2014; U.S. Provisional Patent Application No. 61/692,619, filed Aug. 23, 2012; U.S. Patent Publication No. 2014/0055990, published Feb. 27, 2014; U.S. Provisional Patent Application No. 61/694,159, filed Aug. 28, 2012; U.S. Pat. No. 8,878,440, issued Nov. 4, 2014; U.S. Patent Publication No. 2014/0062341, published Mar. 6, 2014; U.S. Patent Publication No. 2015/0077019, published Mar. 19, 2015; PCT Publication No. WO2014/039683, published Mar. 13, 2014; U.S. Provisional Patent Application No. 61/728,150, filed Nov. 19, 2012; U.S. Patent Publication No. 2014/0139116, published May 22, 2014; U.S. Non-provisional patent application Ser. No. 14/950,823, filed Nov. 24, 2015; PCT Publication No. WO2014/078854, published May 22, 2014; U.S. Provisional Patent Application No. 61/764,395, filed Feb. 13, 2013; U.S. Patent Publication No. 2014/0225521, published Aug. 14, 2014; U.S. Provisional Patent Application No. 61/849,841, filed Jul. 24, 2013; U.S. Patent Publication No. 2015/0028693, published Jan. 29, 2015; PCT Publication No. WO2015/013437, published Jan. 29, 2015; U.S. Provisional Patent Application No. 61/878,425, filed Sep. 16, 2013; U.S. Patent Publication No. 2015/0078005, published Mar. 19, 2015; PCT Publication No. WO2015/039120, published Mar. 19, 2015; U.S. Provisional Patent Application No. 61/933,733, filed Jan. 30, 2014; U.S. Pat. No. 9,185,777, issued Nov. 10, 2015; PCT Publication No. WO2015/116812, published Aug. 6, 2015; U.S. Provisional Patent Application No. 61/905,699, filed Nov. 18, 2013; U.S. Patent Publication No. 2015/0137693, published May 21, 2015; U.S. Provisional Patent Application No. 62/068,517, filed Oct. 24, 2014; U.S. Provisional Patent Application No 62/183,505, filed Jun. 23, 2015; U.S. Non-provisional patent application Ser. No. 14/869,492, filed Sep. 29, 2015; PCT Application No. PCT/US2015/53000, filed Sep. 29, 2015; U.S. Provisional Patent Application No. 62/082,463, filed Nov. 20, 2014; U.S. Non-provisional patent application Ser. No. 14/869,501, filed Sep. 29, 2015; PCT Application No. PCT/US2015/53006, filed Sep. 29, 2015; U.S. Provisional Patent Application No. 62/057,419, filed Sep. 30, 2014; U.S. Non-provisional patent application Ser. No. 14/869,511, filed Sep. 29, 2015; PCT Application No. PCT/US2015/53009, filed Sep. 29, 2015; U.S. Provisional Patent Application No. 62/114,826, filed Feb. 11, 2015; U.S. Non-provisional patent application Ser. No. 14/939,856, filed Nov. 12, 2015; U.S. Provisional Patent Application No. 62/137,666, filed Mar. 24, 2015; U.S. Non-provisional patent application Ser. No. 14/994,569, filed Jan. 13, 2016; U.S. Non-provisional patent application Ser. No. 14/844,944, filed Sep. 3, 2015; U.S. Provisional Patent Application No. 62/208,403, filed Aug. 21, 2015; U.S. Provisional Patent Application No. 62/264,694, filed Dec. 8, 2015 are incorporated herein by reference, in their entirety. Aspects of the embodiments can be modified, if necessary, to employ systems, circuits and concepts of the various patents, applications and publications to provide yet further embodiments.

1. A dimmer plug that is coupleable to a three contact socket of a luminaire, the three contact socket having three female receptacles, the dimmer plug comprising:
a housing having a first face;
only three male electrical contacts, the three male electrical contacts which extend from the first face of the housing, and arranged with respect to one another in a first arrangement;
a receiver housed by the housing and operable to receive input signals; and
circuitry housed by the housing and communicatively coupled to the receiver, the circuitry operable to provide an output signal via one of the three male electrical contacts based on the input signals received by the receiver and operable to control dimming of the luminaire without controlling a line power of the luminaire.

2. The dimmer plug of claim 1 wherein circuitry produces the output signal as a pulse-width modulated signal.

3. The dimmer plug of claim 1 wherein circuitry adjusts a duty cycle of the pulse-width modulated signal to adjust a level of illumination produced by the luminaire.

4. The dimmer plug of claim 1 wherein circuitry produces the output signal as a frequency modulated signal.

5. The dimmer plug of claim 1 wherein circuitry produces the output signal as a digitally coded signal.

6. The dimmer plug of claim 1 wherein circuitry produces the output signal as an analog signal with a range of 0 volts to 100 volts.

7. The dimmer plug of claim 1 wherein the receiver is a radio receiver and further comprising an antenna communicatively coupled to the radio receiver to wirelessly receive the input signals.

8. The dimmer plug of claim 1 wherein the receiver is a wire-line receiver electrically coupled to receive the input signals via an electrical power line coupled to the luminaire.

9. The dimmer plug of claim 1 wherein the three male electrical contacts comprises an AC line contact, an AC neutral contact, and an control signal contact.

10. The dimmer plug of claim 1 wherein the only three male electrical contacts are sized, dimensioned, shaped, and are arranged with respect to one another according to fit a socket that complies with a National Electrical Manufacturer Association (NEMA) C136 specification in existence as of Jan. 1, 2016.

11. The dimmer plug of claim 1 wherein the dimmer plug is a twist lock plug.

12. The dimmer plug of claim 1 wherein the housing has a thickness and a second face, the second face opposed across the thickness of the housing from the first face, and the housing includes a plurality of female electrical contacts accessible from the second face, the female electrical contacts electrically coupled to the circuitry.

13. The dimmer plug of claim 12 wherein the housing includes either five or seven electrical contacts accessible from the second face.

14. The dimmer plug of claim 13 wherein the five or seven electrical contacts are sized, dimensioned, shaped and arranged to receive at least one of a five position dimming controller and a seven position dimming controller.

15. The dimmer plug of claim 14 wherein the housing includes a plurality of pad electrical contacts accessible from the second face.

16. The dimmer plug of claim 15 wherein the circuitry receives the input signals from the dimming controller.

17. The dimmer plug of claim 1, further comprising:
a light sensor communicatively coupled to the circuitry to provide the circuitry with an electrical signal representative of light sensed by the light sensor.

18. The dimmer plug of claim 17 wherein the light sensor includes at least one of either a photo-sensor, a photodetector, and a photo-diode.

19. A dimmer plug that is coupleable to a three contact socket of a luminaire, the three contact socket having three female receptacles, the dimmer plug comprising:
a housing having a first face;
only three male electrical contacts, the three male electrical contacts which extend from the first face of the housing, and arranged with respect to one another in a first arrangement;
a receiver housed by the housing and operable to receive an input signal that is not obtained from a light sensor; and
circuitry housed by the housing and communicatively coupled to the receiver, the circuitry operable to provide an output signal via one of the three male electrical contacts based on the input signals received by the receiver.

20. The dimmer plug of claim 19, wherein the circuitry is operable to control dimming of the luminaire without controlling a line power of the luminaire.

21. The dimmer plug of claim 19 wherein the input signal received by the receiver is not representative of a level of light in an external environment, and the circuitry is operable to control dimming of the luminaire based at least in part on the input signal that is not representative of a level of light in the external environment.
